(19) United States
(12) Patent Application Publication
(10) Pub. No.: US 2019/0260740 A1
(43) Pub. Date: Aug. 22, 2019

(54) System, Method, and Apparatus for Data Access Security

(71) Applicant: P.C. Pitstop, Inc., SIOUX CITY, IA (US)

(72) Inventor: Matthew Quincy Riley, Owosso, MI (US)

(73) Assignee: P.C. Pitstop, Inc., Sioux City, IA (US)

(21) Appl. No.: 15/898,376

(22) Filed: Feb. 16, 2018

(51) Int. Cl. H04L 29/06; G06F 21/60; G06F 8/61

(52) U.S. Cl. CPC H04L 63/0876; H04L 63/083; G06F 8/61; H04L 63/10; G06F 21/604; H04L 63/0861

(57) ABSTRACT

Protecting a computer by installing, on the computer software, software running before providing general access of the computer by a user. The software validates access by the user by way of a primary authorization (for example, by username and password, fingerprint recognition, facial recognition, voice recognition, retinal scan). Responsive to passing of the validating access by the user by way of the primary authorization, the software validates access by the user by way of a secondary authorization, the secondary authorization comprising validating by one or more of a location of the computer, a serial number of the computer, and a MAC address of a communications adapter of the computer.

### FIELD

This invention relates to computer security and more particularly to a system for protecting a device from unauthorized access.

### BACKGROUND

Currently, many computing devices attempt to provide a secure computing environment. Any computing device (including cellular phones) is subject to intrusion by unauthorized persons. When the computing device is lost or stolen, an unauthorized person is often able to access the computing device, obtain sensitive data that is stored on the computing device, and access remote systems that are typically accessed by a user of the computing device. For example, if a smartphone is stolen, the thief often obtains full access to all files on the smartphone, including pictures, tax returns, confidential files, etc. Further, as many users store passwords on their smartphone, the thief is often able to access remote systems such as banking system, corporate data systems, cloud files systems, etc.

To thwart such access, many computing devices have security systems to make it more difficult for a thief to gain access to the computing device. Unfortunately, many owners of such computing devices either have a false sense of security or, by their own actions, reduce the robustness of any security provided. For example, for smartphones, some users utilize a numeric sequence that is “swiped” to access their smartphone. The first thing a thief will do when the illegally obtain a smart phone is to look at the display at an angle to see this swipe patterns of fingerprints left behind from the last time the rightful user accessed the smartphone. After a few tries, the thief has access to the smartphone. Other types of security include passwords, facial scans, fingerprint recognition, voice recognition, etc.; all of which require that the user be vigilant and careful, as most systems includes some sort of backdoor entry should the primary security fail. For example, if the fingerprint scanner fails or the camera fails, or the user changes hairstyle and has a bad sunburn, there needs to be another way to access the computing device. This alternate access is typically a user name and password.

There is a delicate balance between effort and levels of security. As security becomes tighter, users find ways to make accessing their computing devices easier. When password aging is required, users often find algorithmic ways to remember passwords (e.g. passw0rd!1, passw0rd!2). When password construction requires numbers and special characters, users often need to write down their passwords or they will forget the password. Since the password is needed when accessing the computing device, the written password is often located near the computing device, for example taped under the keyboard or inside the smartphone case. Therefore, efforts to make it more difficult for a thief to access a computing device often make it more difficult for a user to remember their credentials and, therefore, such results in either weaker credentials or in secondary methods of remembering the credentials.

Given such weak protection against unauthorized entry, it is well known that many users provide easy access to various network resources once entry to the computing device is made. Many users allow the operating system to cache usernames and passwords for various network resources such as corporate data systems and applications, financial resources (banking, retirement accounts . . . ), subscription services, cloud data (e.g. cloud boxes having important files), retail web sites (e.g. on-line retailers), airline loyalty programs, etc. Once access is made to the computing device, the thief not only has a computing device that the thief can sell, the thief has a tool that is usable to order product, purchase airline tickets, make cash withdrawals from accounts, buy a cappuccino, etc. Further, by now having access to the user's communications applications and contacts, the thief can masquerade as the user in communications with family and friends of the user or the thief is able to sell the contact list to those wanting to market to various individuals by email or text.

Further, password reuse (using the same passwords for accessing different accounts/sites) is an issue as, once a thief obtains the password for a site that has lower security, the thief is able to try that same password at other sites. This is one way that corporations are compromised.

What is needed is a system that will utilize more than just a username and password to restrict access.

### SUMMARY

A system for protecting a computer from unauthorized access is described. The system uses user identification and authorization as a first line of defense, then utilizes a location of the device, serial number of the device, and/or various MAC addresses of the device to further control access by the user.

In one embodiment, the system for protecting a computer includes a computer with software running on the computer before the computer provides general access. The software validates a user of the computer by way of a primary authorization and validates access to the computer by the user by way of a secondary authorization. The secondary authorization includes validation by one or more of a location of the computer, a serial number of the computer, and a MAC address of a communications adapter of the computer. The software provides general access to the computer only upon successful completion of the primary authorization and the secondary authorization.

In another embodiment, a method of protecting a computer includes installing, on the computer software, software running before providing general access of the computer by a user. The software validates access by the user by way of a primary authorization (for example, by username and password, fingerprint recognition, facial recognition, voice recognition, retinal scan). Responsive to passing of the validating access by the user by way of the primary authorization, the software validates access by the user by way of a secondary authorization, the secondary authorization comprising validating by one or more of a location of the computer, a serial number of the computer, and a MAC address of a communications adapter of the computer.

In another embodiment, program instructions tangibly embodied in a non-transitory storage medium, containing at least one instruction for providing security to a computer includes computer readable instructions running on the computer running before providing general access of the computer by a user validating access by the user by way of a primary authorization. The computer readable instructions running on the computer, responsive to passing of the validating access by the user by way of the primary authorization, computer readable instructions running on the computer validating access by the user by way of a secondary authorization, the secondary authorization comprising validating by one or more of a location of the computer, a serial number of the computer, and a MAC address of a communications adapter of the computer.

### BRIEF DESCRIPTION OF THE DRAWINGS

The invention can be best understood by those having ordinary skill in the art, by referencing the following detailed description when considering the accompanying drawings, in which:

FIG. 1 illustrates a data connection diagram of the computer access security system.

FIG. 2 illustrates a schematic view of a typical computer protected by the computer access security system.

FIG. 3 illustrates a schematic view of a typical server computer system.

FIG. 4 illustrates a sample master authorization file of the computer access security system.

FIGS. 5-9 illustrate exemplary program flows of the computer access security system.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

Throughout this description, the term, “computer” refers to any system that has a processor and runs software. One example of such is a personal computer. Another example is a smartphone or tablet. The term, “user” refers to a human that has an interest in the computer, perhaps a user who is using the computer.

In general, the user of the system, method, and apparatus being described utilizes multiple parameters to protect against unwanted access of computers and data. Such parameters include the typical what you know (e.g. username/password) but enhanced protection is provided by other parameters including location and/or fixed data accessible within a device such as serial numbers, hardware addresses (e.g. MAC addresses), etc. In this way, even if a criminal learns or can determine a user's username and password, if a device is stolen, it will likely not be used in the same location as it would have been used in the past. Likewise, if that criminal, having the user's username and password, tries to access a data service from another device (e.g. access a corporate database, access an on-line bank account, order products), that device will lack the requisite fixed data (e.g. will have a different serial number). The present invention, selectively takes into account such parameters before authorizing access to the device and/or remote data services.

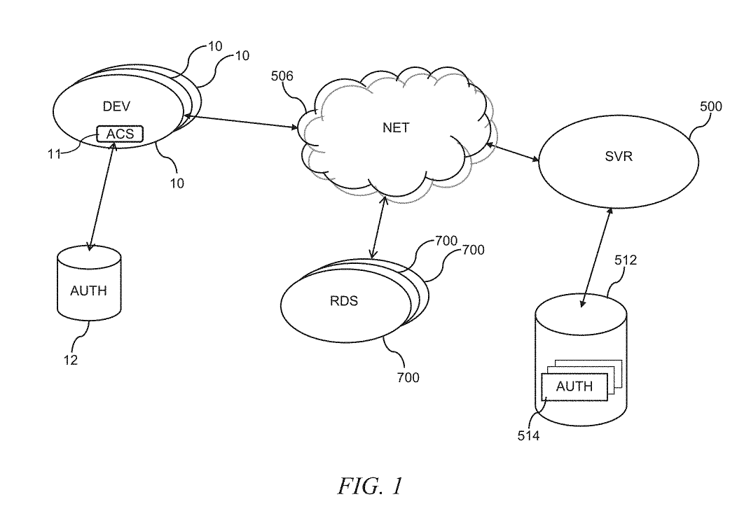

Referring to FIG. 1, a data connection diagram of the exemplary computer security system. In this example, one or more devices 10 (e.g., personal computer, smartphone, tablet computer, desktop computer) communicate through a network 506 (e.g. the Internet, local area network, etc.) to one or more remote data services 700 (e.g., corporate data systems, online banking systems, retailers, airlines, social networks) and/or a server computer 500.

There are many remote data services 700 that need be protected from unauthorized access. The general population does not want unauthorized users to access their bank accounts, retail accounts (e.g. to purchase goods and services), airline frequent flyer accounts, etc. Corporate individuals need to protect unauthorized access to remote data services 700 that contain proprietary data such as marketing information, personnel, product plans, etc. Government employees need to protect from unauthorized access to government data files, plans, secret email, etc.

Each device 10 is pre-loaded with access control software 11. The access control software 11 executes when the device 10 initialize or resumes from a suspended or sleeping state and the access control software 11 reads the local authorization data 12 (e.g. pre-stored authorization data within persistent memory) to determine what is needed to provide access to the device 10. If access to the server 500 is possible (e.g. Wi-Fi access), authorization data 514 is retried from the server 500 and the local authorization data 12 is updated. The access control software 11 then requests inputs from the user of the device 10 of a primary authorization (e.g. a username, password, voice sample, image, fingerprint scan, retinal scan) and the access control software 11 accesses various subsystems within the device 10 to discover the other parameters that are needed such as serial numbers, MAC addresses, location, etc. Once the parameters that are required based upon the authorization data 12 are found/provided, access to the device 10, and hence access to remote data services 700, are provide,

The server computer 500 has access to data storage 512 for maintaining and managing the authorization data 514 that are stored in the data storage 512 for each device 10. In some embodiments, the data storage 512 is networked storage.

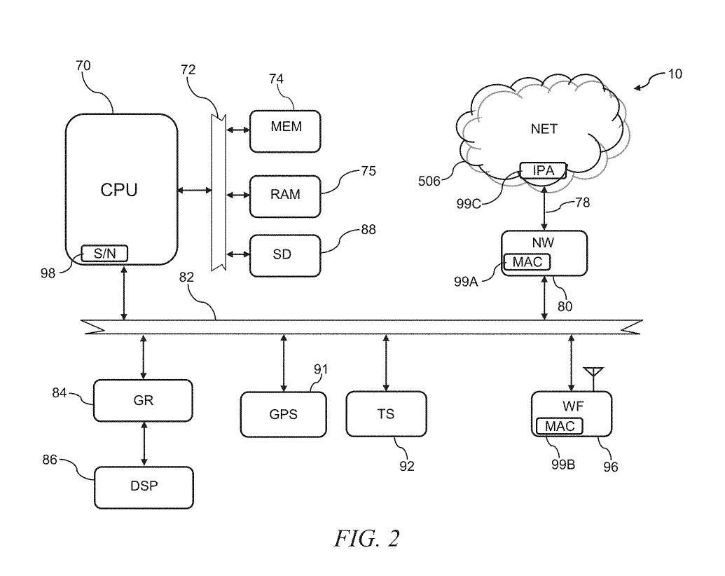

Although one path between the device(s) 10 and the server 500 is shown going through the network 506 as shown, any known data path is anticipated. For example, the Wi-Fi transceiver 96 (see FIG. 2) of the device 10 is used to communicate with the wide area network 506, which includes the Internet, and, consequently, with the server computer 500.

The server computer 500 transacts with the access control software 11 that is running on the device(s) 10 through the network(s) 506. The access control software 11 synchronizes local authorization data 12 with the master authorization data 514 at the server, as will be discussed.

Referring to FIG. 2, a schematic view of a typical device 10 is shown. Access control software 11 runs on the device (e.g., computer, smartphone) for providing access protection to the device 10 and remoted data services 700. Although the devices 10 are typically computers, many other processor-based systems are equally anticipated including, but not limited to smartphones, cellular phones, portable digital assistants, routers, thermostats, fitness devices, etc.

The example device 10 represents a typical device used for computing and accessing remote data service 700. This exemplary device 10 is shown in its simplest form. Different architectures are known that accomplish similar results in a similar fashion, and the present invention is not limited in any way to any particular device 10 system architecture or implementation. In this exemplary device 10, a processor 70 executes or runs programs in a random-access memory 75. The programs are generally stored within a persistent memory 74 and loaded into the random-access memory 75 when needed. In some devices 10, a removable storage slot 88 (e.g., compact flash, SD) offers removable persistent storage. The persistent memory 74, random access memory 75, and SIM card are connected to the processor by, for example, a memory bus 72. The random-access memory 75 is any memory suitable for connection and operation with the processor 70, such as SRAM, DRAM, SDRAM, RDRAM, DDR, DDR-2, etc. The persistent memory 74 is any type, configuration, capacity of memory suitable for persistently storing data, for example, flash memory, read only memory, hard drives, solid-state drives, battery-backed memory, etc. In some exemplary devices 10, the persistent memory 74 is removable, in the form of a memory card of appropriate format such as SD (secure digital) cards, micro SD cards, compact flash, etc.

Also connected to the processor 70 is a system bus 82 for connecting to peripheral subsystems such as a cellular network interface 80, a graphics adapter 84 and a touch screen interface 92. The graphics adapter 84 receives commands from the processor 70 and controls what is depicted on the display 86. The touch screen interface 92 provides navigation and selection features.

In general, some portion of the persistent memory 74 and/or the removable storage 88 is used to store programs, executable code, phone numbers, contacts, and data, etc. In some embodiments, other data is stored in the persistent memory 74 such as audio files, video files, text messages, etc.

The peripherals are examples, and other devices are known in the industry such as global positioning subsystems 91, speakers, microphones, USB interfaces, cameras, microphones, Bluetooth transceivers, Wi-Fi transceivers 96, image sensors, temperature sensors, etc., the details of which are not shown for brevity and clarity reasons.

The network interface 80 connects the device 10 to the network 506 through any known or future protocol such as Ethernet, Wi-Fi, GSM, TDMA, LTE, etc., through a wired or wireless medium 78. There is no limitation on the type of cellular connection used. The network interface 80 provides data and messaging connections between the computer 10 and the server through the network 506.

Many devices 10 have fixed value registers for certain subsystems such as the processor, system, and communications adapters. The values stored in these fixed value registers are read-only (cannot be altered) and, in many cases are unique or semi-unique. By semi-unique, the values are predominately unique, but there is a small probability of a few overlapping values. In the example device 10, the CPU 70 has a serial number 98 that is read-only and cannot be altered. The serial numbers are sometimes programmed into the processor 70 during manufacture by laser cutting of links or electrically opening fused links on the substrate of the processor 70. Also in this example, the network interface 80 has a MAC address 99A and the Wi-Fi transceiver 96 has a MAC address 99B. The network attach point has an IP Address 99C. MAC addresses 99A/99B are typically read-only, programmed during manufacture of the interface, and are generally unique such that two network interfaces on a single network will not interfere with each other. IP addresses 99C are unique networking addresses.

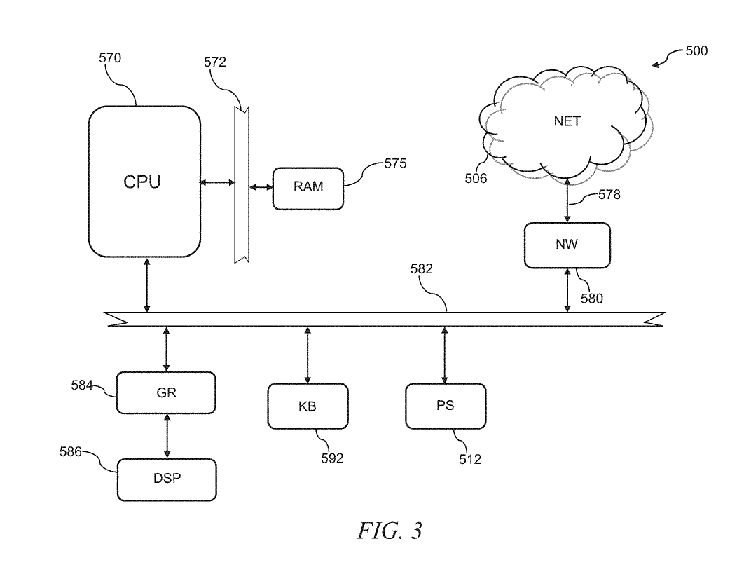

Referring to FIG. 3, a schematic view of a typical server computer system (e.g., server 500) is shown. The example server computer system 500 represents a typical server computer system used for back-end processing, generating reports, displaying data, etc. This exemplary server computer system 500 is shown in its simplest form. Different architectures are known that accomplish similar results in a similar fashion and the present invention is not limited in any way to any particular computer system architecture or implementation. In this exemplary computer system, a processor 570 executes or runs programs in a random-access memory 575. The programs are generally stored within a persistent memory 574 and loaded into the random-access memory 575 when needed. The processor 570 is any processor, typically a processor designed for computer systems with any number of core processing elements, etc. The random-access memory 575 is connected to the processor by, for example, a memory bus 572. The random-access memory 575 is any memory suitable for connection and operation with the processor 570, such as SRAM, DRAM, SDRAM, RDRAM, DDR, DDR-2, etc. The data storage 512 is any type, configuration, capacity of memory suitable for persistently storing data, for example, magnetic storage, flash memory, read only memory, battery-backed memory, magnetic memory, etc. The data storage 512 is typically interfaced to the processor 570 through a system bus 582, or any other interface as known in the industry.

Also shown connected to the processor 570 through the system bus 582 is a network interface 580 (e.g., for connecting to a data network 506), a graphics adapter 584 and a keyboard interface 592 (e.g., Universal Serial Bus—USB). The graphics adapter 584 receives commands from the processor 570 and controls what is depicted on a display 586. The keyboard interface 592 provides navigation, data entry, and selection features.

In general, some portion of the data storage 512 is used to store programs, executable code, data, master authorization data 514, and other data, etc.

The peripherals are examples and other devices are known in the industry such as pointing devices, touch-screen interfaces, speakers, microphones, USB interfaces, Bluetooth transceivers, Wi-Fi transceivers, image sensors, temperature sensors, etc., the details of which are not shown for brevity and clarity reasons.

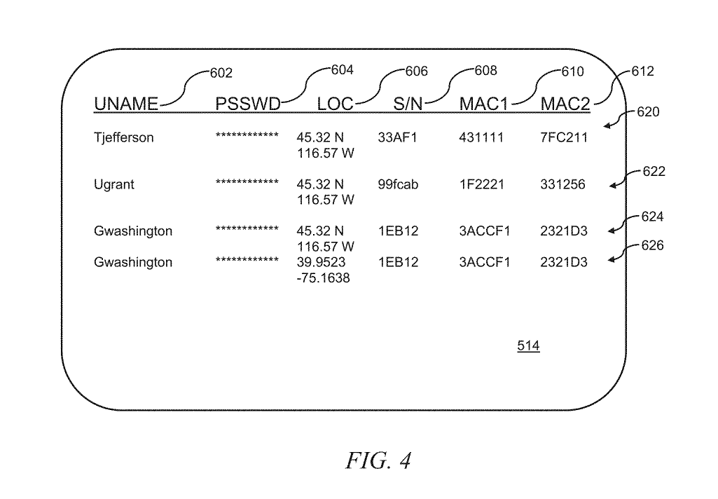

Referring to FIG. 4, sample master authorization data 514 is shown. In this sample master authorization data 514, four fictitious entries 620/622/624/626 are shown for brevity reasons. Although each fictitious entry 620/622/624/626 includes a user name 602, a password 604 (e.g. hash encrypted), a location 606, a serial number 608, a first MAC address 610, and a second MAC address 612 (or IP address), there is no restriction on the number or type of parameter included in the master authorization data 514. For example, some devices 10 have three MAC or IP addresses 99A/996/99C (e.g. one for each of an Ethernet adapter, a Blue-tooth adapter, and a Wi-Fi adapter). Further, in some embodiments, some or all of the fields for each entry are blank or unpopulated. A blank field often represents a data item that is not present in the device 10 that is used by the associated user. For example, some devices 10 have no serial number or have only one communications adapter, and therefore a single MAC address.

In some embodiments, the master authorization data 514 is used to determine if a user has access to a device 10 while, in some embodiments, the master authorization data 514 is also used to determine, after the user has access to a device 10, what external access is provided to that user. For example, in order to access the device 10, the user need provide a primary credential such as a password or fingerprint, but in order to access a remote data site (e.g. a banking web site), the user must also be within a certain location as set in the master authorization data 514. Additionally, the computer access security system determines/identifies when the user is operating on a virtual machine and restricts access to certain remote data sites (e.g. banking web sites) when the user is operating on a virtual machine.

Note that although the location 606 is shown as a single-point (a latitude and longitude), it is fully anticipated that the location 606 be a range of locations or an area emanating from the single-point. For example, within a mile of the latitude/longitude or a rectangle defined by two latitude/longitude points, as a user typically operates in a wider locality.

Note also that the third and fourth fictitious entries 624/626 are for the same username 602, having the same values for serial number 608, first MAC address 610, and second MAC address 612; but having a different value for location 606. This is one way of representing that this user (Gwashington) is authorized to use this device 10 and access data from multiple locations. It is fully anticipated that, through administrative mechanisms, temporary entries are created when a user travels. For example, if a user goes on vacation to Canada for one week, an entry is created allowing that user to use his/her device 10 in Canada. It is anticipated that the temporary entry be time stamped and has an expiration date/time, such that the user is only allowed to use his/her device 10 in that location for the period of time anticipated (e.g. the duration of the vacation).

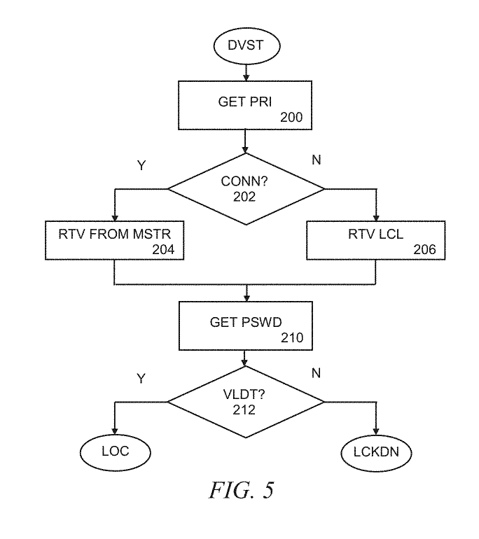

Referring to FIGS. 5-9, exemplary program flows of the computer access security system are shown.

It is anticipated that portions of the exemplary program flow execute on a user device such as a computer 10 while portions of the exemplary program flow execute on the server 500.

In this example, the flow starts when the device 10 initializes, either during initial startup (hard reset/power cycle) or during resumption from hibernation or standby. The computer access security system gets the primary identifier of the user 200. In the authorization data 514, for brevity, the primary identifier is a username 602, though any other primary identifier is anticipated such as a fingerprint, facial recognition, eye scan, etc. For brevity purposes, a username 602 is used in the following examples. Next, it is determined 202 it the device 10 has a connection to the server 500. If the device 10 has a connection to the server 500, then the authorization data for this device 10 is retrieved from the server 204. If the device 10 does not have a connection to the server 500, then the authorization data for this device 10 is retrieved from a local copy 206.

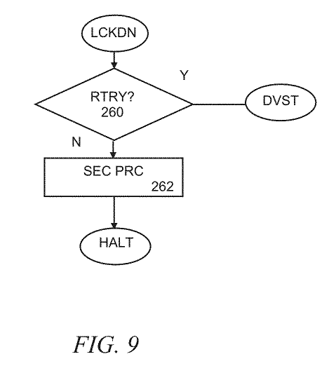

Next, a password is retrieved 210 (e.g. by the user typing a password in this example, but other forms of access security are anticipated such as scanning a fingerprint, etc.). The password is then validated 212, as known in the industry. For example, a one-way hash algorithm is used to encrypt the password that was typed, then the encrypted password is compared to the password 604 for that user. If the password is not validated 212, then a lockdown procedure (see FIG. 9) is performed.

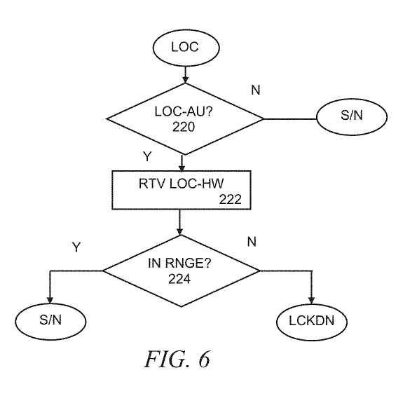

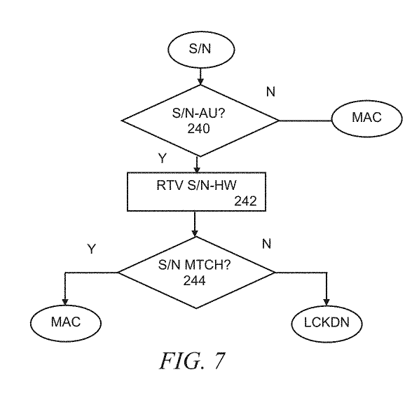

If the password is validated 212, then further validation is performed as in FIG. 6. If the further validations don't include location authorization (e.g., there is no entry for location in the authorization data), then serial number checking is performed as in FIG. 7.

If the further validations do include location authorization (e.g., there is one or more entries for location in the authorization data), then the location of the device 10 is retrieved 222, for example, by reading a location from the global positioning subsystems 91 of the device 10 or a location based upon an internet provider from the network adapter 80 or the Wi-Fi adapter 96, etc. Note that there are many ways to determine a location of the device 10 and all are included here within. If the location of the device 10 that was retrieved is not in range of the location authorization data 606 (e.g. within a specific distance of the value in the location authorization data 606 or the location authorization data 606 includes a specific range or list of locations), then the lockdown procedure of FIG. 9 is performed. If the location of the device 10 that was retrieved is within range of the location authorization data 606, then serial number checking is performed as in FIG. 7.

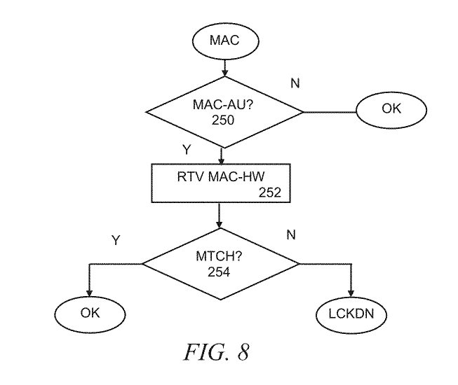

In FIG. 7, the serial number checking is performed. If there is no serial number 608 in the authorization data for this user, then MAC address checking is performed as in FIG. 8. If there is a serial number 608 in the authorization data for this user, then the local serial number is retrieved 242. If the local serial number matches the serial number 608 in the authorization data, then all is well and MAC address checking is performed as in FIG. 8. If the local serial number differs from the serial number 608 in the authorization data for the device 10, then access is denied and the lockdown process is performed as in FIG. 9.

In FIG. 8, MAC address checking is performed. Many subsystems such as Ethernet adapters, Wi-Fi adapters, Bluetooth adapters, cellular interfaces, etc., have somewhat unique addresses, called MAC addresses or other, that allow these devices to co-exist on a network level. In this, one adapter can address another adapter by such addresses, knowing the data packet will get to that adapter and not to other adapters.

If MAC address checking is not performed 250 (e.g. MAC1 610 and MAC2 612 are empty), then all steps have passed and access is allowed. If MAC address checking is to be performed (e.g. MAC1 610 or MAC2 612 is populated), then the MAC address is retrieved 252 from the interface adapter of the device 10 and compared to the corresponding stored MAC address (e.g. MAC1 610 and MAC2 612). In some embodiments, several MAC (or adapter) addresses are provided and each has to match the corresponding fields from the authorization data for the device 10 (e.g. MAC1 610 and MAC2 612 both need to match). As many MAC (or adapter) addresses as desired are checked for a match 254. If all MAC (or adapter) addresses of the device 10 match the corresponding fields from the authorization data for the device 10, the access is allowed. If any MAC, IP, and/or hardware addresses of the device 10 do not match the corresponding fields from the authorization data for the device 10, the access is prevented and the lockdown procedures of FIG. 9 are run.

In FIG. 9, an exemplary lockdown procedure is described. In this, provisions are optionally made for retrying. For example, if the username and password don't match, it is possible that the user mistyped the password or caps-lock was enabled. In such, it is determined 260 if a retry is allowed (e.g. only a certain number of retries are allowed over a specified period of time). If it is determined 260 that a retry is allowed, the above is repeated starting with requesting the primary identifier of the user 200. If it is determined 260 that a retry is not allowed, then a course of action is taken. There are many courses of action conceived based upon levels of security desired. For example, if the device 10 is of top-secret in nature, then upon failure of the authorization, some or all data stored at the device is erased (e.g. wipe using special algorithms that prevent recovery of the data). A security procedure 262 is performed, for example, erasing critical data, locking the device, etc.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for computer security, the system comprising:
a computer;
software running on the computer before the computer provides general access, the software validates a user of the computer by way of a primary authorization and validates access to the computer by the user by way of a secondary authorization;
whereas the secondary authorization comprises the software validates by one or more of a location of the computer, a serial number of the computer, an IP address associated with the computer, and a MAC address of a communications adapter of the computer;
the software provides general access to the computer only upon successful completion of the primary authorization and the secondary authorization.

2. The system of claim 1, wherein the primary authorization comprises the software requesting a username and a password from the user and the software comparing the username and the password to a previously set username and a previously set password.

3. The system of claim 1, wherein the primary authorization comprises one or more inputs of a voice sample, an image, a fingerprint scan, and a retinal scan, the software comparing the voice sample, the image, the fingerprint scan, or the retinal scan to a respective previously captured voice sample, a respective previously captured image, a respective previously captured fingerprint scan, or a respective previously captured retinal scan.

4. The system of claim 1, wherein upon failure of the primary authorization, the software again validates the user of the computer by way of the primary authorization for a predetermined maximum number of attempts.

5. The system of claim 4, wherein upon failure of the primary authorization for the predetermined maximum number of attempts, the software locks the computer.

6. The system of claim 4, wherein upon failure of the primary authorization for the predetermined maximum number of attempts, the software erases sensitive data from the computer.

7. The system of claim 4, wherein upon failure of the primary authorization for the predetermined maximum number of attempts, the software provides an artificial environment to fool the user and the software captures data from the user for forensic reasons.

8. The system of claim 1, wherein upon failure of the secondary authorization, the software locks the computer.

9. The system of claim 1, wherein upon failure of the secondary authorization, the software erases sensitive data from the computer.

10. A method of protecting a computer, the method comprising:
installing on a computer software, the software running before providing general access of the computer by a user;
the software validating access by the user by way of a primary authorization; and
responsive to passing of the validating access by the user by way of the primary authorization, the software validating access by the user by way of a secondary authorization, the secondary authorization comprising validating by one or more of a location of the computer, a serial number of the computer, an IP address associated with the computer, and a MAC address of a communications adapter of the computer.

11. The method of claim 10, wherein the primary authorization includes at least one of a username, password, voice sample, image, fingerprint scan, and retinal scan.

12. The method of claim 10, further comprising the step of: responsive to failing of the validating access by the user by way of the secondary authorization, locking the computer.

13. The method of claim 10, further comprising the step of: responsive to failing of the validating access by the user by way of the secondary authorization, erasing sensitive data from the computer.

14. Program instructions tangibly embodied in a non-transitory storage medium for providing security to a computer, wherein the at least one instruction comprises:
computer readable instructions running on the computer running before providing general access of the computer by a user validating access by the user by way of a primary authorization; and
responsive to passing of the validating access by the user by way of the primary authorization, computer readable instructions running on the computer validating access by the user by way of a secondary authorization, the secondary authorization comprising validating by one or more of a location of the computer, a serial number of the computer, an IP address associated with the computer, and a MAC address of a communications adapter of the computer.

15. The program instructions tangibly embodied in the non-transitory storage medium of claim 14, wherein the primary authorization includes computer readable instructions running on the computer receiving and verifying at least one of a username, password, voice sample, image, fingerprint scan, and retinal scan.

16. The program instructions tangibly embodied in the non-transitory storage medium of claim 14, further comprising responsive to failing of the validating access by the user by way of the primary authorization, computer readable instructions running on the computer validating the user of the computer by way of the primary authorization for a predetermined maximum number of attempts.

17. The program instructions tangibly embodied in the non-transitory storage medium of claim 14, further comprising responsive to failing of the validating access by the user by way of the secondary authorization, computer readable instructions running on the computer locking the computer.

18. The program instructions tangibly embodied in the non-transitory storage medium of claim 14, further comprising responsive to failing of the validating access by the user by way of the secondary authorization, computer readable instructions running on the computer erasing sensitive data from the computer.
